(19) United States
(12) Patent Application Publication
(10) Pub. No.: US 2004/0055206 A1
(43) Pub. Date: Mar. 25, 2004

(54) Fishing lure holder

(76) Inventor: James E. Broberg, Crystal Lake, IL (US)

Correspondence Address: MATHEW R. P PERRONE, JR., ATTORNEY AT LAW, 210 SOUTH MAIN STREET, ALGONQUIN, IL, 60102, US

(21) Appl. No.: 10/252,752

(22) Filed: Sep. 23, 2002

(51) Int. Cl. A01K 97/04; A01K 97/00

(52) U.S. Cl. 43/54.1

(57) ABSTRACT

The present invention concerns a system for securing a fishing lure having a leader to a surface. The invention includes a lure holder having a spool defining opposing contact points for receiving a leader. An extension is also provided which is affixed to the spool. The extension has a distal end which defines a hook receptacle. The length of the extension is adjustable. In addition, the receptacle is located a spaced distance from the spool to permit the creation of a biasing force which urges a hook into the receptacle. Lastly, a mounting bracket is provided and configured to receive the holder.

### BACKGROUND OF THE INVENTION

The present invention concerns a fishing lure holder. More specifically, the present invention is a fishing lure holder that includes a spool for receiving the lure's leader and an extension with a hook holder for releasably receiving the hook of the lure.

### SUMMARY OF THE INVENTION

In sport fishing, lures and their attached leaders need to be safely and securely stored, yet easily accessible. The present invention provides a solution to these competing needs.

The present invention provides a spool or other means which functions to receive the leader. The leader is typically secured by wrapping it around the spool. An extension depends from the spool. A hook receptacle is located at a distal end of the extension for receiving the sharp hook.

A lure is secured to the holder by first inserting the hook into the receptacle. The leader is then wrapped around the spool. This not only stores the leader, it also puts the lure, leader and hook under tension. This biases the hook into the receptacle.

### DESCRIPTION OF THE DRAWINGS

These and other features, objects and advantages of the present invention will become apparent from the following description and drawings wherein like reference numerals represent like elements in several views, and in which:

FIG. 1 is a perceptive view of one embodiment of the present invention.

FIG. 2 is a side view of the embodiment shown in FIG. 1.

FIG. 3 is a front view of one embodiment of the spool.

FIG. 4 is a perspective view of another embodiment of the present invention.

FIG. 5 is a top view of the embodiment shown in FIG. 4.

FIG. 6 is a front view of the embodiment shown in FIG. 4.

FIG. 7 is a front view of an alternate extension which may be used with the present invention.

### DESCRIPTION OF THE PREFERRED EMBODIMENTS

Set forth below is a description of what are currently believed to be the preferred embodiments or best examples of the invention claimed. Future and present alternatives and modifications to the preferred embodiments are contemplated. Any alternates or modifications in which insubstantial changes in function, in purpose, in structure or in result are intended to be covered by the claims of this patent.

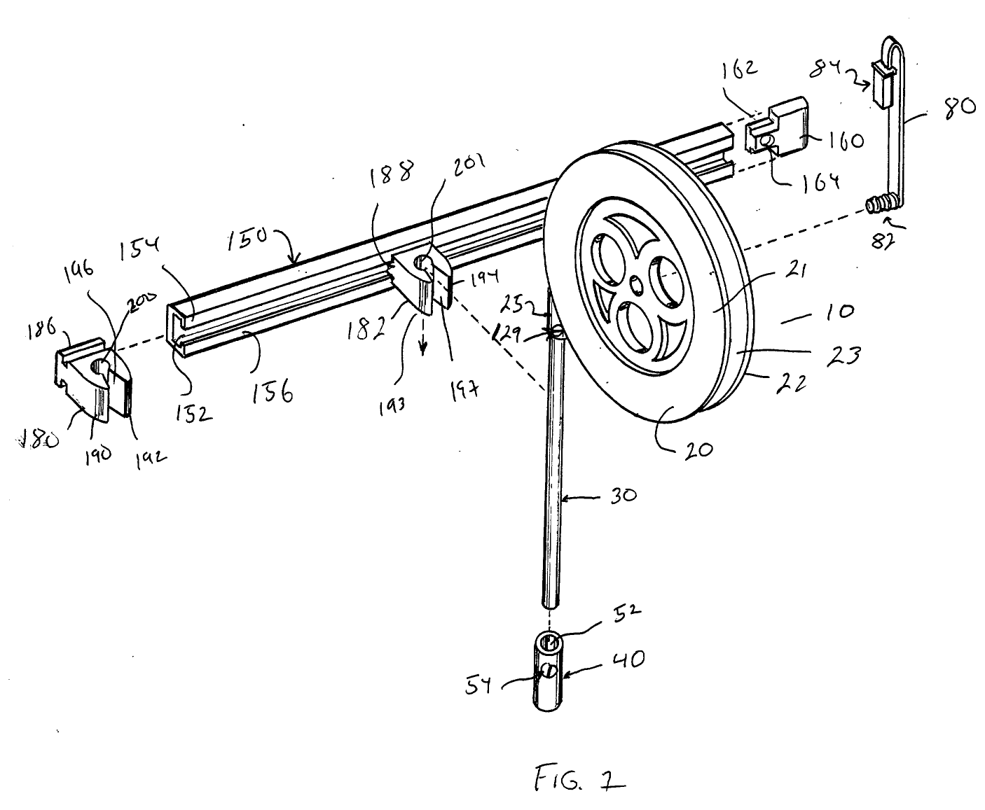

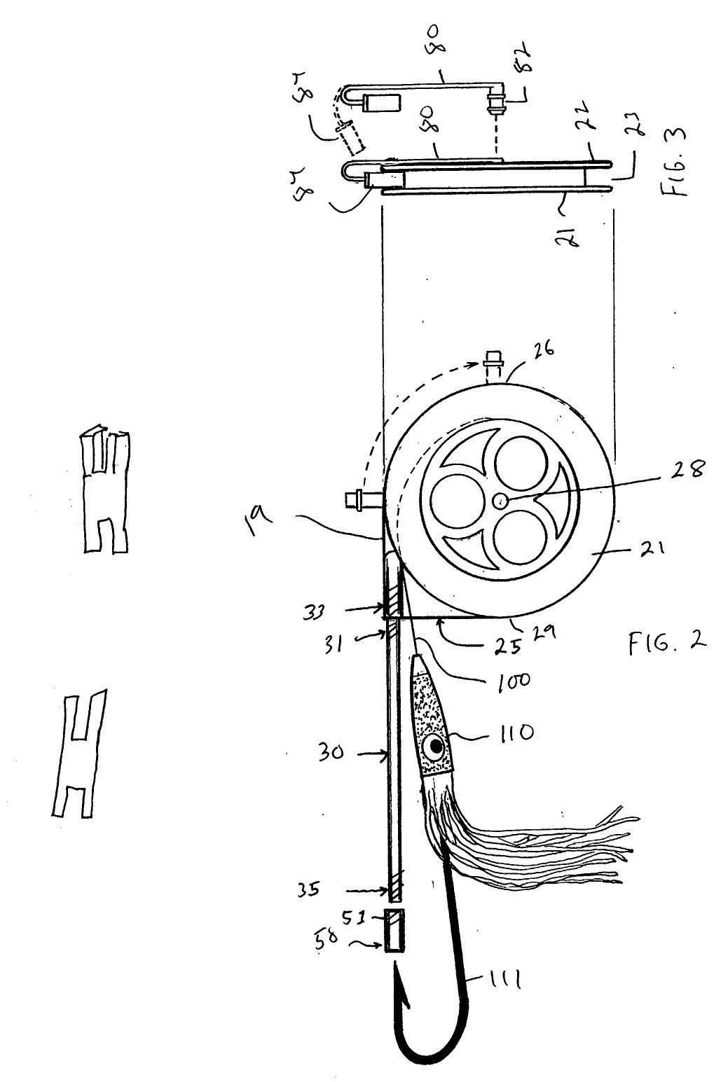

Referring to FIG. 1, the present invention concerns a lure holder 10 which includes a base 19 having a spool 20 having two opposing side walls 21 and 22 which define an annular groove 23. Groove 23 receives and holds leader 100 of lure 110 as shown in FIG. 2.

Spool 20 may be rotatable about an axis or stationary. In addition, although shown as being circular in shape, spool 20 may be configured in other shapes that permit leader 100 to be wound around the spool. To do this, at a minimum, spool 20 needs to provide two opposing points of contact 26 and 29 to effectively retain leader 100.

Spool 20 may be made of either plastic or metallic in construction. A corrosion resistant material is preferred not only for the spool but for all of the components of the device since the device may be exposed to the harsh conditions caused by salt water and other outdoor elements.

Section 25 of spool 20 is adapted to receive extension 30 which may be a metallic tubular rod or of some other elongated type of construction. Extension 30 may be adjustingly retained through the use of a set screw 129 as shown in FIG. 1. Alternately, section 25 may include internal threads 33 as shown in FIG. 2 which coact with external threads 31 on extension 30.

Located on the distal end of the extension is a hook receptacle 50 which may be made of plastic. Receptacle 50 may include a bore 52 that is sized to receive extension 30 and hook 111. The receptacle may be attached to extension 30 through the use of internal threads 51 which coact with threads 35 on extension 30. Alternately, receptacle 50 may include a set screw 51 that adjustably secures the receptacle to the extension. In yet another embodiment, the receptacle may simply be mounted to the extension. Lastly, the receptacle may be formed as part of the extension itself rather than as a separate component.

A line lock 80 may also be provided to hold the leader within the spool. Lock 80 includes a first plug 82 sized to fit within aperture 28 on spool 20. A second plug 84 is sized to form a friction fit with groove 23.

To assist in storing the holder and attached lure, a mounting bracket 150 may be provided that is attachable to a support structure. The bracket is elongated and defines an internal channel 152 and has opposing retaining portions 154 and 156. Mounting cap 160 is used to secure the bracket to the support structure. Cap 160 includes a section 162 sized to mate with and to be retained within channel 152. An aperture 164 for receiving a mounting fastener is also provided.

Clips 180 and 182 are provided for receiving the holder. As with mounting cap, the clips include sections 186 and 188 that are configured to mate within channel 152 and to be slideably retained within the channel. Deformable prongs 190-194 extend from the clips and form passageways 196 and 197 which lead to apertures 200 and 201. The apertures are sized to releasably receive a designated portion of the spool or extension.

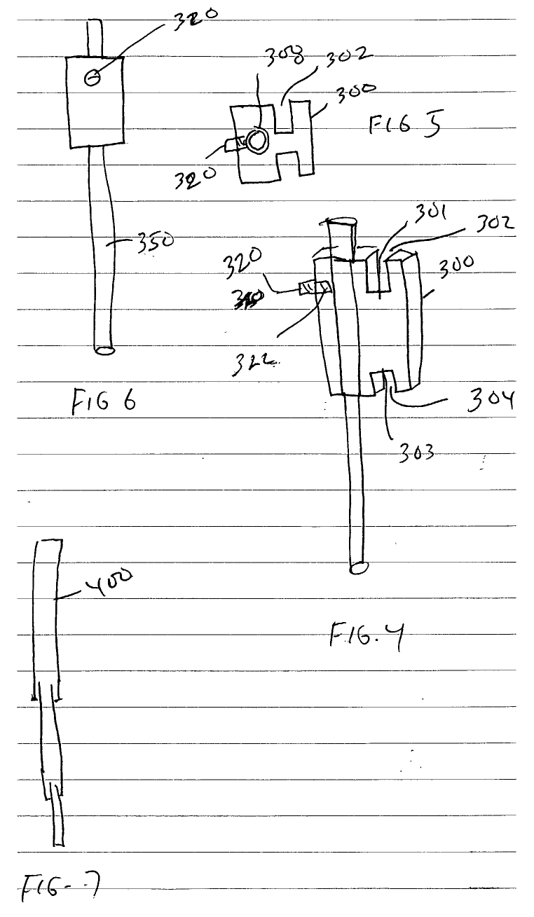

FIGS. 4-6 show an alternate embodiment of the present invention. Holder 300 includes two opposing located notches 302 and 304 that provide opposing contact points 301 and 303 for engaging and securing the leader 100.

Holder 300 also includes a bore 308 sized to receive extension 350. Extension 350 may sized to form a friction fit within the bore so as to be retained in the bore yet remain positionable. This may also be accomplished by a set screw 320 that coacts with internal threads 322 in holder 300.

As shown in FIG. 7, extension 400 may be telescopically arranged. This allows the length of the extension to be adjusted as needed.

In use, hook 111 of lure 110 is inserted into the opening in the hook receptacle. Leader 100 is then wound around the spool. This should be done in such a manner so as to create a biasing force that urges the hook into the receptacle.

To insure that the biasing force may be created for lures of various lengths, the effective length of the extension needs to be greater than the length of the largest lure and hook that is to be used with the holder. Alternately, for ease of use, the extension may be adjustable in effective length. This may be accomplished by the use of the coacting threads and set screws discussed above. The threads and set screws allow the receptacle to move along the extension to increase the effective length. In addition, the length of the extension may also be adjusted by moving a portion of the extension relative to the holder by use of the set screws. Lastly, a telescoping extension may be used to accomplish this adjustment as well.

After the lure is affixed to the holder, the lure and holder may be releasably secured to the mounting bracket. This is done by inserting a portion of the holder or extension into mounting clips 180 or 182 so that the device comes to rest within the aperture provided. The use of the clips allows multiple lures to be mounted in a safe and easily accessible manner.

While the preferred embodiments of the present invention have been illustrated and described, it will be understood by those of ordinary skill in the art that changes and other modifications can be made without departing from the invention in its broader aspects. Various features of the present invention are set forth in the following claims.

What is claimed is:

1. A holder for releasably securing a fishing lure with attached leader comprising:
a spool defining opposing contact points for receiving a leader;
an extension affixed to said spool, said extension having a distal end;
a hook receptacle located at said distal end of said extension for receiving a hook from a lure;
said receptacle located a spaced distance from said spool, whereby said leader may be wound around said spool to create a biasing force which urges a hook into said receptacle.

2. The device of claim 1 wherein said spool is rotatable.

3. The device of claim 1 wherein said spool is circular in shape.

4. The device of claim 1 wherein said spool defines multiple contact points.

5. The device of claim 1 wherein said extension is adjustable in length.

6. The device of claim 5 wherein a set screw permits the length of said extension to be adjusted.

7. The device of claim 5 wherein coacting threads permit the length of said extension to be adjusted.

8. The device of claim 1 wherein a set screw permits said receptacle to be positioned on said extension.

9. The device of claim 1 wherein coacting threads permit said receptacle to be positioned on said extension.

10. The device of claim 1 wherein said holder includes a line lock.

11. The device of claim 1 further including a mounting bracket configured to receive said holder.

12. A system for securing a fishing lure having leader to a surface comprising:
a lure holder having a spool defining opposing contact points for receiving a leader;
an extension affixed to said spool, said extension having a distal end;
a hook receptacle located at said distal end of said extension for receiving a hook from a lure;
said receptacle located a spaced distance from said spool to permit the creation of a biasing force which urges a hook into said receptacle; and
a mounting bracket configured to receive said holder.

13. The device of claim 12 wherein said spool is rotatable.

14. The device of claim 12 wherein said spool is circular in shape.

15. The device of claim 12 wherein said spool defines multiple contact points.

16. The device of claim 12 wherein said extension is adjustable in length.

17. The device of claim 16 wherein a set screw permits the length of said extension to be adjusted.

18. The device of claim 16 wherein coacting threads permit the length of said extension to be adjusted.

19. The device of claim 12 wherein a set screw permits said receptacle to be positioned on said extension.

20. The device of claim 12 wherein coacting threads permit said receptacle to be positioned on said extension.

21. The device of claim 12 wherein said holder includes a line lock.
